(19) United States
(12) Patent Application Publication
(10) Pub. No.: US 2017/0083678 A1
(43) Pub. Date: Mar. 23, 2017

(54) System and Methods for Sensory Controlled Satisfaction Monitoring

(71) Applicant: Roy ITTAH, Ashdod (IL)

(72) Inventor: Roy ITTAH, Ashdod (IL)

(21) Appl. No.: 15/310,796

(22) PCT Filed: May 14, 2015
(86) PCT No.: PCT/IB15/53565

§ 371 Date: Nov. 14, 2016

Related U.S. Application Data
(60) Provisional application No. 61/993,310, filed on May 15, 2014.

(51) Int. Cl. G06F 19/00; G06Q 50/00; G06Q 30/06

(52) U.S. Cl. CPC G06F 19/3418; G06Q 30/06; G06Q 50/01

(57) ABSTRACT

The disclosure relates to systems and methods for an automatic sensory controlled satisfaction monitoring system based upon physiological sensing detection technology coupled with externally measured stimulants, operable to monitor continuously the satisfaction level and to communicate passively with various external entities, such as social, medical/health, business nature and the like. More specifically, the present disclosure supports non-unified pricing and payments according to a satisfaction scale of the experience, and further allows for open access to various internet content and services payable according to actual consumption combined with the real-time/average satisfaction level.

### FIELD OF THE INVENTION

The present invention relates to sensory controlled satisfaction monitoring. In particular, the invention relates to sensing, monitoring and detecting of physiological aspects coupled with externally measured environmental stimulants associated with a situation, and a system operable to respond passively, in real-time to provide authentic and reliable feedback transferrable into various actions such as sensory payment, social engagement and the like.

### BACKGROUND OF THE INVENTION

Satisfaction may have various meanings and interpretations, and may be context related. Oxford Dictionary defines satisfaction as “Fulfilment of one's wishes, expectations, or needs, or the pleasure derived from this,” indicating a sense of well-being. Business associated terminology, may define “Customer level of approval when comparing a product's (service) perceived performance with his or her expectations.”

For example, monitoring satisfaction is a business common tool, as a business can only exist by the grace of satisfied customers. Satisfied customers may provide free advertisement, and their loyalty contributes directly to positive business results. Accordingly, keeping clients satisfied demands continuous attention. Realistic and reliable feedback from customers is important, enabling discussion of performance, quick response and implementation of targeted changes.

Interviews, questionnaires or performing surveys are various practical tools used in business, to measure satisfaction and better understand what a person (possibly a customer) feels in a specific situation (such as vacation, theater, shopping, work environment and the like).

Furthermore, another example is associated with sharing of satisfaction in personal or social engagement events. Based mainly on verbal communication, but may take other forms, using digital media communications tools, such as telephone, mails, instant messaging, social networks and the like.

The importance associated with satisfaction monitoring reflected by various attempts to automate the process to reach an efficient and more reliable process, such as U.S. patent Ser. No. 12/777,031 titled, “Method of automatic customer satisfaction monitoring through social media”. Further, banking institutions implemented usage of an expert system developed to provide a solution for better customer service, combining semantic analysis of sentiment and customer satisfaction monitoring with advanced natural language customer interaction features.

One common denominator of all these interactions is that they are ‘time-shifted’ and do not necessarily represent the real ‘contact-moment’ of the experience.

### SUMMARY OF THE INVENTION

There is a need for an automatic satisfaction-monitoring system, which can produce real-time, authentic, and reliable satisfaction information. Such a satisfaction monitoring system, may further allow the passive functionalities, such as a sensory related satisfaction payment, sharing experiences, social engagement and the like, based upon authentic and real satisfaction level. The current disclosure addresses this need.

It is according to one aspect of the current disclosure to present an automatic satisfaction-monitoring system for sensing a level of satisfaction of a subject, such as a person, by monitoring a set of physiological body signals and external environmental stimulants, said satisfaction-monitoring comprising:

a sensing unit associated with the person and operable to detect said set of physiological body signals;

an external stimulant unit configured to measuring the external environmental stimulants associated with a situation; and

a processing unit operable to compute continuously the level of satisfaction;

wherein the level of satisfaction is determined using a combined input from the sensing unit and the external stimulant unit; and further configured to trigger passively an associated satisfaction-transaction.

The term “satisfaction-transaction” is used herein to refer to any transaction triggered by a satisfaction level as determined by any combination of sensing units, external stimulant units and the like. By way of example only, a satisfaction-transaction may be a monetary transaction, an electronic transaction, a voting transaction, an approval transaction such as the provision of a social label such as a “like” label, a “favorite” label, a “star” label or the like as well as combinations thereof.

Where appropriate, the associated satisfaction-transaction is transmittable via a communication unit.

Optionally, the associated satisfaction-transaction is configured to be automatically triggered.

Optionally, the associated satisfaction-transaction is configured to be manually triggered.

As appropriate, the associated satisfaction-transaction is a payment transaction directed to a business entity providing a product or a service according to the level of satisfaction. Variously, the payment transaction is selected from a group consisting of: a monetary transaction, an electronic transaction, a voting transaction, an approval transaction and combinations thereof.

As appropriate, the associated satisfaction-transaction is a social transaction directed to members of a social network for sharing an experience according to the level of satisfaction.

As appropriate, the associated satisfaction-transaction is a report transaction to an entity for reporting an event according to the level of satisfaction.

Optionally, the processing unit is further operable to send an indication to said person via an internal device, configurable according to user preferences, and may be a wearable gadget. Variously, the wearable gadget is selected from a group consisting of: a cloth, a watch, a glasses, a wristband, a ring, an earring, a necklace, an electronic eye contact, an implanted electronic unit, an implanted bio-mechanic unit and combinations thereof.

As required, the sensing unit comprising: at least one sensor array operable to collect data pertaining to a plurality of sensory parameters of the subject; and a satisfaction analyzer operable to combine each of the plurality of sensory parameters to determine the set of physiological body signals as an input signal for the processing unit. Further, the satisfaction analyzer comprises a data collector operable to receive data from said plurality of sensory parameters, and the data collector comprises a sensory data filter operable to filter the plurality of sensory parameters.

Where appropriate, the data collector comprises a sensory data buffer operable to buffer the plurality of sensory parameters.

As required, the external stimulant unit comprising: an external stimulant data collector operable to collect data pertaining to the environment; and a locator unit operable to provide current location of the person.

Additionally, the system further comprising a personalization unit configured to provide user personal preferences associated with the person and the situation.

Optionally, the personalization unit further comprises an authentication module operable to provide privacy of the person.

It is according to another aspect of the disclosure, a method is taught for sensing a level of satisfaction of a person by monitoring a set of physiological body signals and external environmental stimulants. The method is for use in an automatic satisfaction-monitoring system, the system comprising a sensing unit, an external stimulant unit and a processing unit.

The method for operating said automatic satisfaction-monitoring system in an improved manner, the method comprising:

detecting, by the sensing unit, a set of physiological body signals of the person;

measuring, by the external stimulant unit, external environmental stimulants associated with a situation;

computing, by the processing unit, the level of satisfaction using combined input from the sensing unit and the external stimulant unit; and

triggering, by the processing unit, an associated satisfaction-transaction, passively.

As appropriate, the step of triggering an associated satisfaction-transaction further comprises transmitting, via a communication unit, the associated satisfaction-transaction to an external entity.

Optionally, the step of transmitting said associated satisfaction-transaction to an external entity is configured to be automatically transmitted.

Optionally, the step of transmitting said associated satisfaction-transaction to an external entity is configured to be manually transmitted.

As appropriate, the step of transmitting the associated satisfaction-transaction comprises transmitting a payment transaction to the external entity, the external entity is a business entity providing a product or a service according to the level of satisfaction.

Variously, the payment transaction is selected from a group consisting of: a monetary transaction, an electronic transaction, a voting transaction, a “like” transaction and combinations thereof.

As appropriate, the step of transmitting the associated satisfaction-transaction comprises transmitting a social transaction to the external entity, the external entity is at least one member of a social network for sharing an experience according to the level of satisfaction.

As appropriate, the step of transmitting the associated satisfaction-transaction comprises transmitting a report transaction to the external entity for reporting an event according to the level of satisfaction.

Optionally, the step of triggering an associated satisfaction-transaction further comprises sending, by a processing unit, an indication to the person.

As appropriate, the step of detecting a set of physiological body signals of the person comprises the steps of:

collecting data pertaining to a plurality of sensory parameters of the person from at least one sensor array;

buffering each of the plurality of sensory parameters into a sensing unit buffer;

filtering the plurality of sensory parameters in the sensing unit buffer; and

converting the plurality of sensory parameters into a set of physiological body signals.

As appropriate, the step of measuring external environmental stimulants comprises the steps of:

collecting data pertaining with a situation associated with the person;

collecting data pertaining with the environment associated with the person; and

providing current location of the person.

As appropriate, the method further comprising the step of configuring user personal preferences associated with the person and the situation.

As appropriate, the method further comprising the step of authenticating the person such that privacy of the person is kept.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only. Further, the drawings are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a block diagram showing the main components of an automatic satisfaction-monitoring system according to one embodiment of the present invention;

FIG. 2 is a schematic diagram representing the main components of a satisfaction-monitoring unit for a per person monitoring, in an automatic satisfaction-monitoring system;

FIG. 3 is a block diagram representing the structure 300 of the main software modules of a satisfaction-monitoring system; and

FIG. 4 is a flowchart showing a method for performing automatic passive satisfaction communication with external entities (social/health/medical/business).

FIG. 5 is a flowchart showing a method for analyzing the level of satisfaction automatically accompanied with passive communication of the satisfaction-transaction to external entities.

### DESCRIPTION OF THE PREFERRED EMBODIMENTS

It is noted that the systems and methods of the disclosure herein may not be limited in their application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

Aspects of the present invention relate to providing system and methods for automatic, reliable and authentic satisfaction-monitoring operable to couple and communicate passively with various external entities, wherein said external entities may be of social, medical/health, business nature and the like, possibly offering non-unified pricing and payments according to a satisfaction scale of the experience.

Optionally, the current disclosure provides open access to various internet content and services payable according to actual consumption combined with the satisfaction level.

The automatic satisfaction-monitoring system may rely on physiological signal detection and body measurements combined with external environmental stimulants' assessment to yield an output of a satisfaction structure. The satisfaction-monitoring system of the current disclosure may use various types of computerized sensors, possibly operable with wearable technologies, smart-fabric technology and the like.

The level of satisfaction monitored from using a product or a service, reflected real-time of various physiological aspects of body responses to external/environment stimulants. Based upon the outputted satisfaction structure, for example, the satisfaction monitoring system may initiate automatically (namely, in a passive manner) related social reporting, payments in a variety of forms and the like.

Optionally, the various operable functionalities, in response to physiological responses configured to provide continuous signal indications. Additionally or alternatively, the system may continually buffer related data, to provide an overall satisfaction image and possible statistics.

Where appropriate, the environmental stimulants may be an event such as watching a movie, a show, a TV program; eating in a restaurant, being in a vacation, swimming in a pool, listing to music, dancing in a night club, shopping at the mall and the like. Accordingly, the event/scenario is determined to be associated with a specific service/product provider and further operable to determine the various contributors, if the event/scenario is so reflected.

Where appropriate, the environmental stimulants may be associated with various service providers, such as internet service providers, communications service providers, transportation services, hotel services, repair services (plumbing, electricity, sewage, home appliances and the like), electrical and water authority's services, local municipality services, governmental organizations services and the like.

The output satisfaction metric may be a simple binary response to an event, identified scenario, in terms of happy/unhappy, or may further associate a range, say one to ten, or a more complex output structures, such as a various possible metric, accordingly.

Optionally, the social reporting communicated automatically to a social community, depending on the degree of sensory satisfaction. As appropriate, the social reporting communicated to a social network group, a specific category of social members, a specific list associated with the event/identified scenario or any specifically preconfigured list and the like.

Accordingly, the level of sensory satisfaction may result in positive social reporting (happy consumer'), for being happy while consuming a service, for example, and may result in a negative social reporting (unhappy consumer'), for being unhappy with the service.

Optionally, electronic payments may be made in real-time, in accordance to a pre-configured sensory threshold satisfaction scale, in various forms such as physical payment (financial transaction to a business entity), virtual payments (future virtual coins such as BitCoins, for example), but may use another possible mechanism of paying by “likes,” voting and so forth. Further, electronic payments may be reflected in real-time.

Accordingly, positive level of sensory satisfaction (happy consumer') may result in maximal payment for satisfactory service provided, additional tipping and the like. Negative level of satisfaction (unhappy consumer') may result in minimal payment, full reimbursement or even to the extent of some level of compensation for being unhappy with the consumed service.

### Scenario/Event Examples:

By way of an illustrative example, listening to a song playing in the background, actively or passively, may generate measureable sensory satisfaction (passive or active). The level of threshold stimulus generated due to the event (event, is the song playing) coupled with the details (such the song title, band/singer, holder's rights and the like) may trigger automatic electronic royalty transaction payment in a passive manner), optionally in various terms (“likes,” votes, monetary transaction and the like). Optionally, the transaction may require authorization and may further use means such as an electronic wallet.

Another example may be associated with enjoying watching (or disliking) an artistic picture; this may trigger real-time responses, such as social reporting (positive/negative, based upon the level of satisfaction) or some payment to the franchise holder, as detailed hereinabove.

A further example may be associated to eating in a restaurant, enjoying the taste of a meal may result in high satisfaction, generating automatic maximal tipping, for example, or generating a price reduction for a less tasty meal; all reflecting real time level of satisfaction.

Another example related to viewing a film/performance/VOD. In this example, viewing the film/performance/VOD may activate an automatic payment according to the level of satisfaction detected. A fully enjoyable film/performance/VOD will automatically generate an electronic transaction (such as via an electronic wallet, for example) of the full price; average level of satisfaction may activate an average payment; disappointment may deny any payment or provide a free ticket/coupon for the next show/performance/VOD.

It is noted that the issue of consumption is strongly coupled with satisfaction. An enjoyable experience, reflected in high level of satisfaction may trigger a maximal payment or scaled payment, according to the level of satisfaction, and vice versa, a disappointing consumption experience may result in a reduced payment, accordingly. Similarly, social reporting, may be initiated automatically reflecting the experience.

### Physiological Signal Detection Technologies:

Major existing product implementations, using physiological signal detection technologies, may rely on skin contact of the sensor, to obtain the desired physiological information for home healthcare and clinical diagnosis.

Well-known sensing methods include “EEG”, “ECG”, “EMG”, “MRI” “fMRI” (see terminology terms hereinafter) and the like. Yet, these techniques often cause inconvenience and discomfort to users, possibly making them unsuitable for long-term monitoring. The sensing detection technology is advancing in a fast pace and new emerging technologies, based on low power radar technology, become a reality, such as Nanosecond Pulse, Near-field Sensing, wearable nanowire sensor and more. These technologies may use/achieve non-contact sensory detection.

All the mentioned technologies hereinabove, provide the ability to determine user's affective state based on physiological signals and peripheral signals, such as pulse, heart rate, respiratory rate, temperature, skin conductance, blood flow, muscle activity and the like. Such technologies may further enable to analyze facial expression to improve on user's affective state determination.

The term “EEG” refers to electroencephalogram, a tool used to image the brain while it is performing a cognitive task.

The term “ECG” or “EKG” refers to electrocardiogram, is a test that checks for problems with the electrical activity of the heart.

The term “EMG” refers to electromyogram, measures the electrical activity of muscles at rest and during contraction. Nerve conduction studies measure how well and how fast the nerves can send electrical signals.

The term “fMRI”, refers to functional magnetic resonance imaging or functional MRI, a procedure using MRI technology that measures brain activity by detecting associated changes in blood flow.

### Wearable Technology:

The wearable device market is set for gaining accelerated growth in the next years. According to last year's Juniper Research report, wearable technology spending worldwide would hit $1.4 billion in 2013 and jump to $19 billion by 2018. This forecast, strengthened by another study from research firm IDC, earlier this year showed wearable device shipments jumping to 111.9 million by 2018. By the end of 2014, the IDC study claimed, manufacturers will ship more than 19 million wearable devices worldwide.

Wearable technology (called sometimes, wearable gadgets) is a category of technology devices, referring to computer-powered devices or equipment configured for wearing by a consumer/user and often include tracking information related to health and fitness. Wearable devices may include clothing, watches, glasses, wristbands, rings, earrings, necklaces and the like. Wearable computing devices may comprise small sensors providing various features that can range from providing very specific physiological measuring/monitoring features such as heart rate monitoring, motion detection and pedometer capabilities to advanced “smart” functions and features of blood oxygen monitoring using wristband, for example. Such functionality, may provide immediate interaction and response and other features similar to those a smartphone or smart-watch offers. Optionally, such sensor devices may enable taking photos; synchronize with your mobile devices; communicating externally and the like.

It is noted that when referencing wearable technology or wearable gadgets, it is meant to further include components such as electronic eye contacts, implanted electronic/bio-mechanics units and the like.

### Smart-Fabric Sensor Technology:

Smart-fabric technology may be sensor based, representing the rapidly changing and advancing technology of the electronic textile.

Sensing functionality added to various fabrics may apply modifications to textile substrates, depending on the level of integration into the fabric platform. Further, fabric sensors tailored to measure force, pressure, chemicals, humidity and temperature variations, for example, enable creating interactive fabrics, an integration of fabric or human tissue with ‘micro’ technology of accessories and devices. As such, standardization of smart-fabric sensing techniques and e-textile fabrication methods are emerging, with materials, connectors, fabric circuits, sensors and variously, encapsulation and fabrication methods associated with fabric technologies prove to be customizable and moving towards becoming a more mature technology.

The future will bring light and durable micro devices, affordable and flexible such that embedding into a cloth is feasible and possibly washable as well as answering the fashion agenda.

It is noted that other technologies may be used, such as implementation of micro antennas and high-frequency circuits, processing analog and digital signals.

### Description of the Embodiments

The various embodiments detailed hereinafter, describe various aspects of the current disclosure of the automatic satisfaction-monitoring system in terms of a possible architecture, passive communication, interactions and management of interactions.

### System Architecture:

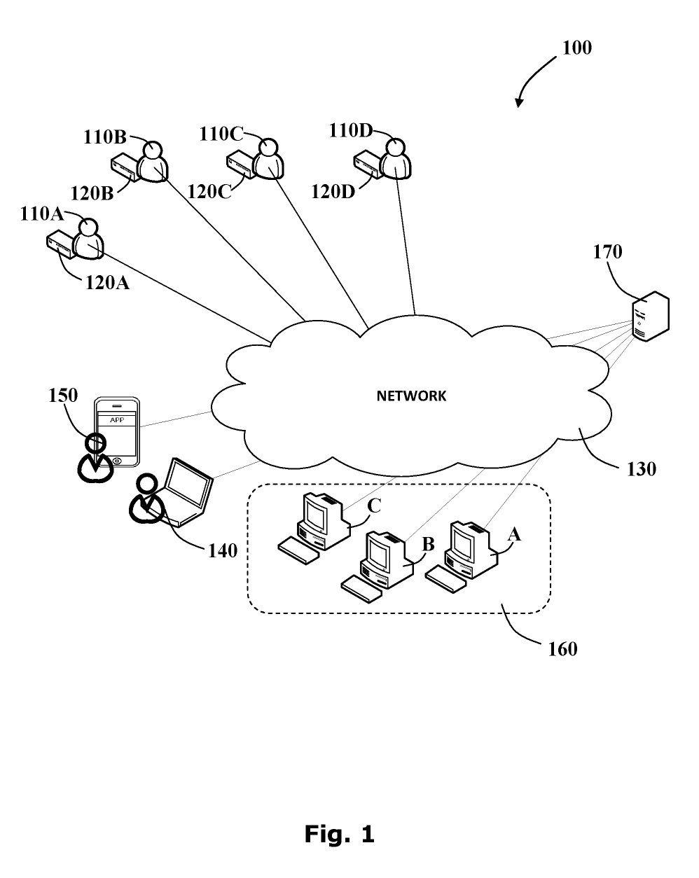

Reference is now made to FIG. 1 showing a block diagram of the main components of an embodiment of a possible automatic satisfaction-monitoring system 100, adapted to compute satisfaction output in various forms, such as a satisfaction metric and the like. Where appropriate, the satisfaction output structure may further communicate via the communication module, for example, to various external entities triggering context related functionality. Such functionality may result in payment (referred to as sensory payment) according to the level of satisfaction, when the external entity is a business entity providing a product or a service. The external entity may be a social entity, when sharing satisfaction experiences with friends of a social network, for example. The satisfaction-monitoring system 100 includes of a group of persons 110A-D, each associated with a sensor array 120A-D, in communication via a communication network 130 with social external entities using various digital devices such as laptops 140 or smartphones 150, for example. The persons may further be in communication with external business/medical/health entities 160, represented by A-C. The satisfaction-monitoring system 100 possibly centrally managed or configured to communicate related information to a remote server 170.

The sensor array may use various sensor elements integrated into various personal wearable designs, thus use various personal monitoring devices for continuous physiological monitoring of wearable gadgets implementing wearable technology. The personal wearable designs may take the form of watches, glasses, earrings, rings, necklaces, jewelry, bracelets and the like configured to detect various physiological changes of brain waves, pulse, heart rate, face expressions, temperature and the like.

It is noted that various wearable gadgets already exist in the market place, such as Bluetooth headphones, glasses (such as Google Glass and the like), smart watches (such as Apple iWatch and the like), smart bracelet (such as Heartbeat Sensing Bracelet, continuous Blood Pressure Measurement Bracelet and the like), smart-bands, smart-wristband, wearable authentication technology components, NFC powered rings, gesture control armbands and much more.

Optionally, wearable sensors may facilitate breathing sensors, jacket sensor array, Bluetooth voice trackers and more.

Optionally, the sensor may use advanced adhesives to provide comfortable, secure and low profile physiological monitoring, like fitness bands connectable to smartphones, for example.

Optionally, sensor array may be stitched into fabrics providing overall sensing detection, as described hereinabove (section of Smart-Fabric Sensor Technology).

Variously, sensors are sleek and barely noticeable, and may connect wirelessly to a remote unit such as a smartphone using wireless protocols such as Bluetooth, WiFi, NFC, Zigbee or the like.

### Personal Configurable Unit:

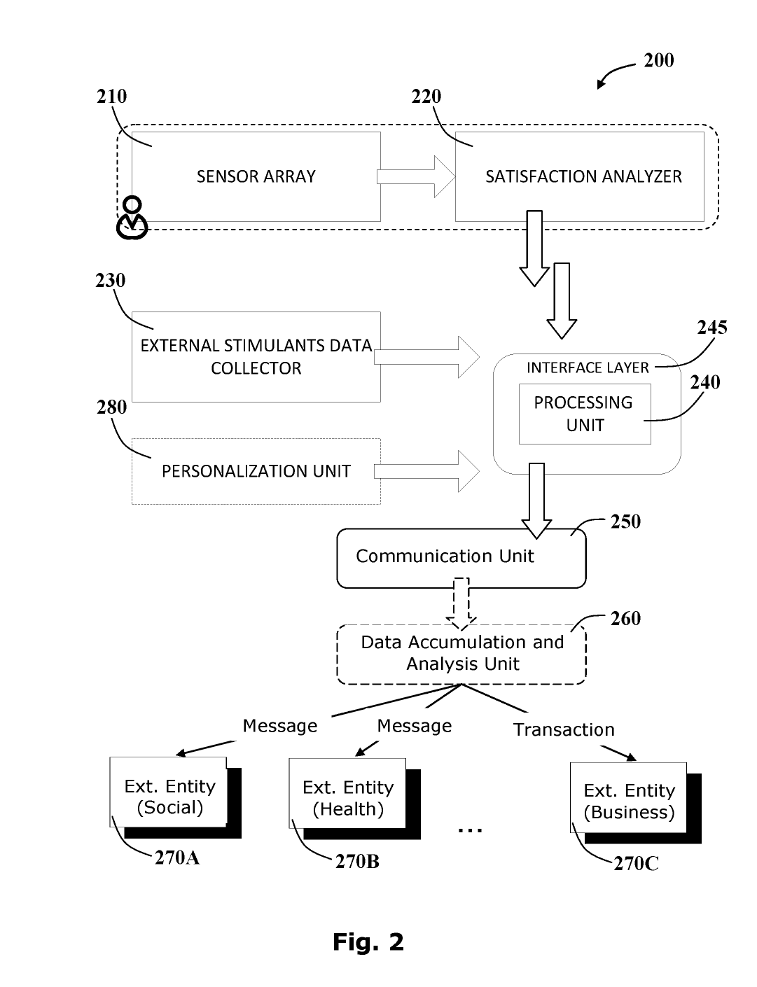

Reference is now made to FIG. 2, a schematic diagram representing the main components of a per-person satisfaction-monitoring unit 200, of an automatic satisfaction-monitoring system. The per-person satisfaction-monitoring unit 200 comprises a sensor array 210 operable to communicate data to a satisfaction analyzer 220, an external stimulant data collector 230, a processing unit 240 accessible via an interface layer 245, and a communication unit 250 operable to enable communication with various external entities (business, social, medical, health and the like) 270A-C.

Optionally, the per-person satisfaction-monitoring unit 200 may include a data accumulation and analysis unit 270 operable to accumulate data from the other users and further perform additional analysis and processing, as appropriate, prior to communicating with the external entities.

Optionally, the per-person satisfaction-monitoring unit 200 may include a personalization unit 280 operable to configure personal user preferences.

Optionally, services or network content for personal consumption may be accessible only if accompanied with active sensory satisfaction measuring tools, such as the per-person satisfaction-monitoring unit 200.

Optionally, a global “sensory” consumption volume (optionally, in various financial terms) may be determined (possibly via a personalization preference profile, for example), allowing automatic “financial” transaction deducted from such a volume based upon sensory satisfactory service consumption.

It is noted that the external communication may be performed according to the output of a satisfaction metric, generated by the processing unit 240. Accordingly, and possibly based upon user preferences (as determined by the personalization unit), the communication may include personal notification message directed to social engagement via a social network. Where appropriate, the communication triggered handles business matters, such as ‘sensory’ payments, reflecting level of satisfaction from/of an event.

It is further noted that the satisfaction analyzer 220 and the external stimulant data collector 230 are configured to communicate associated data of each unit to the processing unit 240 and further allow the continuous monitoring of the satisfaction level, outputted via a satisfaction structure, possibly as a satisfaction metric.

Optionally, the user preference profile may provide functionality to enable social engagement, while limiting sensory payment to be in virtual terms only, such as “likes” and voting (or other virtual coins), possibly preventing or barring any business matters altogether.

Optionally, the user preference profile may configure sensory payments to request a further approval action, prior to performing the transaction.

### Software Modules:

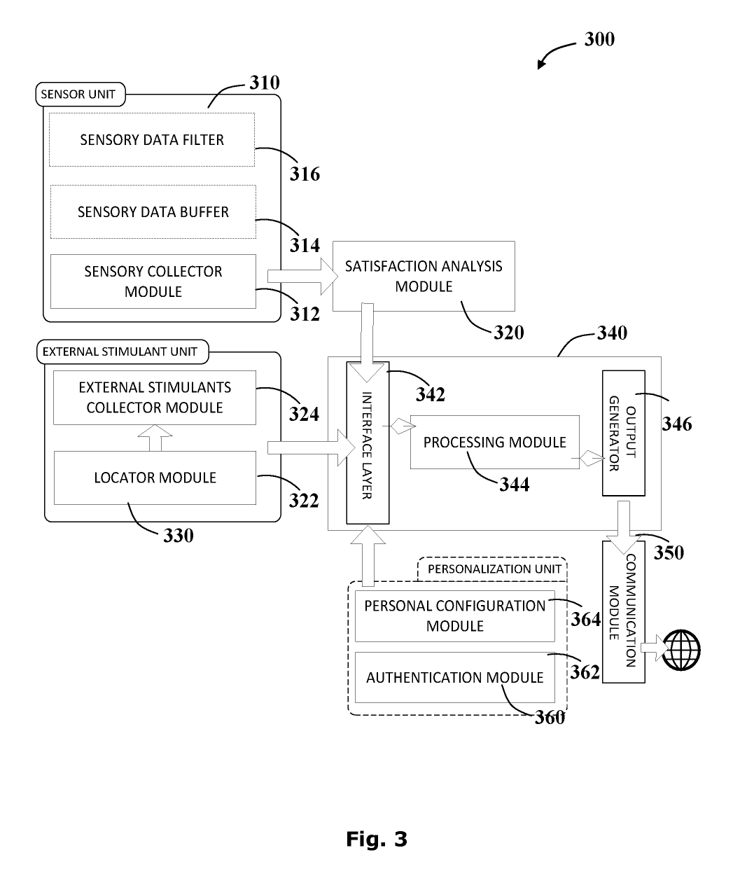

Reference is now made to the block diagram of FIG. 3, representing module structure 300 of one possible embodiment of the software architecture of automatic satisfaction-monitoring system (100, FIG. 1). The software module structure 300 comprises modules of a sensor unit 310, a satisfaction analyzer module 320, modules of an external stimulant unit 330, modules of a processing unit 340 and a communication module 350.

Optionally, the module structure 300 further comprises additional modules such as a personalization unit.

The sensor unit 310 comprise a sensory collector module 312 configured to integrate data collection from the various sensors of the sensor array (210, FIG. 2). Optionally, the sensor unit 310 further comprises a sensory data buffer module 314 configured to buffer gathered data prior to analysis performed, and a sensory data filter module 316, possibly filtering non-context sensing data.

The external stimulant unit 330 comprises a locator module 322, operable to provide location information of the venue and within that venue communicated to an external stimulants collector module 324.

The processing unit 340 comprises an interface layer 342 operable to provide any access (input/output) to the processing module 344 and an output generator 346 configured to generate an output structure, such as a satisfaction metric, for example.

Where appropriate, the personalization unit 360 comprises an authentication module 362 and a personal configuration module 364.

Optionally, personal configuration may affect the analysis as configured via a user preference profile, determining classification of transmission, communication to a specific group of social members and the like.

It will be appreciated that the module structure embodiment of the present invention represents an architecture that may vary according to specific implementations.

### Passive Communication:

It is a particular feature of the invention that any further transaction resulting from the satisfaction-monitoring process (such as business, social communications and the like) are performed automatically, in a passive manner, without the need of consumer intervention, unless otherwise configured, based upon the analysis of sensory physiological measurements of a person and external environmental stimulants.

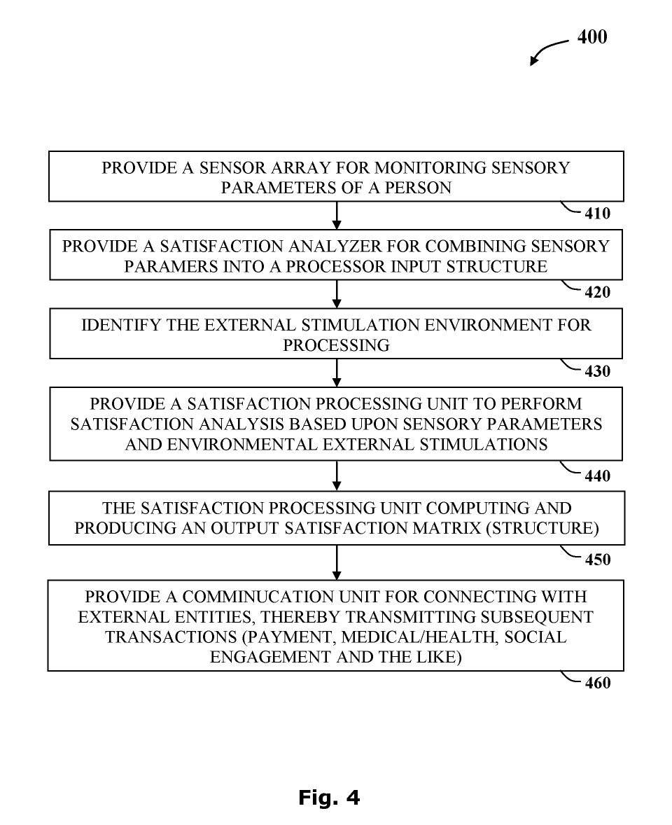

Reference is now made to FIG. 4, a flowchart is presented showing selected steps in a method 400 for performing automatic passive satisfaction communication with external entities in an automatic satisfaction-monitoring system.

The method 400 includes the following steps: providing a sensor array to enable physiological readings for monitoring sensory parameters per person, and determining satisfaction analysis—step 410; providing a satisfaction analyzer to analyze sensory detected parameters, determining a combined satisfaction structure as an input for the satisfaction processing unit—step 420; identifying the externally stimulated environment—the location, the event/identified scenario and external stimulants—step 430; providing a satisfaction processing unit to perform overall satisfaction analysis based upon the sensory parameters and the environmental external stimulants—step 440; computing and producing an output satisfaction structure, such as a satisfaction metric by the satisfaction processing unit—step 450; and providing a communication unit for connecting with the external entities, thereby transmitting subsequent transactions such as payments, medical/health treatment or care, social engagements and the like—step 460.

As appropriate, such method may adopted to express satisfaction level associated with the retail industry, such as rating restaurants, hotels, movies and the like, reflecting the level of satisfaction by “stars” of satisfactions. Hotel star ratings are systems that rank hotels according to quality, forcing existence of specific services and equipment rather than by the actual customer satisfaction. Using a real-time, authentic satisfaction rating system could help in pushing service providers, to constantly strive towards higher satisfaction rate of their products. For example, movie producers may use expert professional services to improve scenes attempting to yield higher satisfaction metric of their production.

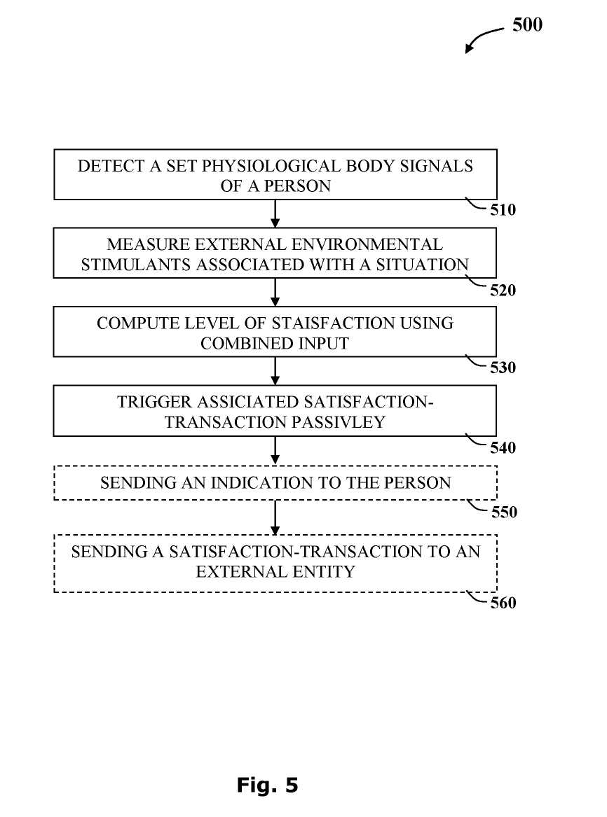

Reference is now made to FIG. 5, a flowchart is presented illustrating a possible selected action of a method 500 for analyzing the level of satisfaction automatically accompanied with passive communication of the satisfaction-transaction to external entities.

The method 500 includes the following steps: detecting a set of physiological body signals for a person—step 510 optionally by using at least one set of sensor array attached to the body of the person; measuring external environmental stimulants associated with a situation of the person—step 520 optionally using by an external stimulant unit; computing the level of satisfaction using combined input from the sensing unit and the external stimulant unit—step 530 by a processing unit; triggering an associated satisfaction-transaction passively—step 540 by the processing unit.

Optionally, sending indication to the person including a summary of the passively analyzed satisfaction-transaction—step 550;

Optionally, sending the satisfaction-transaction an external entity—step 550 via a communication module associated with the processing unit.

It is noted that the external entity may be a business unit providing a service or a product, where the payment associated with satisfaction-transaction may be selected from a group consisting of: a monetary transaction, an electronic transaction, a voting transaction, an approval transaction and the like. Accordingly, the payment is representing the level of satisfaction.

It is noted that the external entity may be at least one member of a social network for sharing the experience of an event according to the level of satisfaction.

It is further noted that the external entity may be a third party person, such as a medic professional/therapist, and the associated satisfaction-transaction comprises transmitting a report transaction to the third party entity for reporting an event according to the level of satisfaction.

Thus the disclosure hereinabove presents various methods and systems which may be used to perform satisfaction level analysis associated with a person in a situation, producing a satisfaction transaction. The scope of the present invention is defined by the appended claims and includes both combinations and sub combinations of the various features described hereinabove as well as variations and modifications thereof, which would occur to persons skilled in the art upon reading the foregoing description.

The methods and systems described hereinabove may be deployed in part or in whole through a machine or device that executes computer software, program codes, and/or instructions on a processor. The processor may be part of a server, client, network infrastructure, mobile computing platform, stationary computing platform, or other computing platform. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

The methods and systems described herein may be deployed in part or in whole through a machine that executes computer software on a server, client, firewall, gateway, hub, router, or other such computer and/or networking hardware.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The scope of the disclosed embodiments may be defined by the appended claims and includes both combinations and sub combinations of the various features described hereinabove as well as variations and modifications thereof, which would occur to persons skilled in the art upon reading the foregoing description.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least 10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

1. An automatic satisfaction-monitoring system for sensing a level of satisfaction of a subject by monitoring a set of physiological body signals and external environmental stimulants, said satisfaction-monitoring system comprising:
a sensing unit associated with said subject and operable to detect said set of physiological body signals;
an external stimulant unit configured to measure said external environmental stimulants; and
a processing unit operable to compute the level of satisfaction;
wherein said level of satisfaction is determined using a combined input from said sensing unit and said external stimulant unit; and further configured to trigger passively an associated satisfaction-transaction.

2. The automatic satisfaction-monitoring system of claim 1, wherein said associated satisfaction-transaction is transmittable via a communication unit.

3. The automatic satisfaction-monitoring system of claim 1, wherein said associated satisfaction-transaction is configured to be automatically triggered.

4. The automatic satisfaction-monitoring system of claim 1, wherein said associated satisfaction-transaction is configured to be manually triggered.

5. The automatic satisfaction-monitoring system of claim 1, wherein said associated satisfaction-transaction is a payment transaction directed to a business entity providing a product or a service according to said level of satisfaction.

6. The automatic satisfaction-monitoring system of claim 5, wherein said payment transaction is selected from a group consisting of: a monetary transaction, an electronic transaction, a voting transaction, an approval transaction and combinations thereof.

7. The automatic satisfaction-monitoring system of claim 1, wherein said associated satisfaction-transaction is a social transaction directed to members of a social network for sharing an experience according to said level of satisfaction.

8. The automatic satisfaction-monitoring system of claim 1, wherein said associated satisfaction-transaction is a report transaction to an entity for reporting an event according to said level of satisfaction.

9. The automatic satisfaction-monitoring system of claim 1, wherein said processing unit is further operable to send an indication to said subject via an internal device.

10. The automatic satisfaction-monitoring system of claim 9, wherein said internal device is a wearable gadget.

11. The automatic satisfaction-monitoring system of claim 9, wherein said wearable gadget is selected from a group consisting of: items of clothing, watches, spectacles, wristbands, rings, earrings, necklaces, electronic eye contact devices, implanted electronic units, implanted bio-mechanic units and combinations thereof.

12. The automatic satisfaction-monitoring system of claim 1, wherein said sensing unit comprising:
at least one sensor array operable to collect data pertaining to a plurality of sensory parameters of said subject; and
a satisfaction analyzer operable to combine each of said plurality of sensory parameters to determine said set of physiological body signals as an input signal for said processing unit.

13. The automatic satisfaction-monitoring system of claim 12, wherein said satisfaction analyzer comprises a data collector operable to receive data from said plurality of sensory parameters.

14. The automatic satisfaction-monitoring system of claim 13, wherein said data collector comprises a sensory data filter operable to filter said plurality of sensory parameters.

15. The automatic satisfaction-monitoring system of claim 13, wherein said data collector comprises a sensory data buffer operable to buffer said plurality of sensory parameters.

16. A method for sensing a level of satisfaction of a subject by monitoring a set of physiological body signals and external environmental stimulants, for use in an automatic satisfaction-monitoring system, said system comprising a sensing unit, an external stimulant unit and a processing unit,
said method for operating said automatic satisfaction-monitoring system in an improved manner, the method comprising:
detecting, by said sensing unit, a set of physiological body signals of said subject;
measuring, by said external stimulant unit, external environmental stimulants associated with a situation;
computing, by said processing unit, the level of satisfaction using combined input from said sensing unit and said external stimulant unit; and
triggering, by said processing unit, an associated satisfaction-transaction, passively.

17. The method of claim 16, wherein said step of detecting a set of physiological body signals of said subject comprises the steps of:
collecting data pertaining to a plurality of sensory parameters of said subject from at least one sensor array;
buffering each of said plurality of sensory parameters into a sensing unit buffer;
filtering said plurality of sensory parameters in said sensing unit buffer; and
converting said plurality of sensory parameters into a set of physiological body signals.

18. The method of claim 16, wherein said step of measuring external environmental stimulants comprises the steps of:
collecting data pertaining to a situation associated with said subject;
collecting data pertaining with the environment associated with said subject; and
providing current location of said subject.

19. The method of claim 16, further comprising the step of configuring user personal preferences associated with said subject.

20. The method of claim 16, further comprising the step of authenticating said subject such that privacy of said subject is kept.
